(19) United States
(12) Patent Application Publication
(10) Pub. No.: US 2005/0279538 A1
(43) Pub. Date: Dec. 22, 2005

(54) Golf-N-Go Caddy

(76) Inventor: Candido E. Ivey, aurora, CO (US)

Correspondence Address: CANDIDO IVEY, 2958 SOUTH BAHAMA STREET, AURORA, CO, 80013, US

(21) Appl. No.: 10/709,876

(22) Filed: Jun. 2, 2004

(51) Int. Cl. B60K 1/00

(52) U.S. Cl. 180/65.1

(57) ABSTRACT

A cost effective and convenient way for the frequent golfer to have a motorized golf scooter/cart with the individual at all times. A lightweight golf scooter/cart that is affordable and easily transportable without additional towing accessories. The Golf-N-Go Caddy can easily be compacted (fold), can easily be lifted in and out of a vehicle's trunk, and can easily be set up. Simply place the golf bag and clubs within the golf bracket and the golf scooter/cart is conveniently ready to go. When the Golf-N-Go Caddy is not in use on the golf course, the weight of the clubs will conveniently keep the scooter/cart upright on the golf stand, allowing easy access to the clubs.

### DETAILED DESCRIPTION

A single rider two (2), three (3) or four (4) wheeled, lightweight, collapsible, transportable, golf scooter/cart with unique golf bracket and stand powered by electrical motor or gas powered engine. This golf scooter/cart is primarily used to carry and transport a golfer and his or her golf clubs.

1. This scooter/cart will collapse to fit in a standard vehicle's trunk, to make for easy transportation.

2. This scooter/cart is about as lightweight as a large golf bag full of clubs, making it easy for any golfer to use.

3. The weight of the clubs and bag within the unique golf bracket will anchor the scooter in an upright position on the unique golf stand.

4. The three (3) wheel design can have two (2) wheels in the front with one (1) in the back or two (2) wheels in the back and one (1) in the front with the same general features and purposes as the two (2) wheeler without the golf stand.

5. The four (4) wheel design will have four (4) wheels with the same general features and purposes as the two (2) wheeler without the golf stand.
